(19) United States
(12) Patent Application Publication
(10) Pub. No.: US 2009/0234633 A1
(43) Pub. Date: Sep. 17, 2009

(54) SYSTEMS AND METHODS FOR ENABLING INTER-LANGUAGE COMMUNICATIONS

(76) Inventors: Virginia Chao-Suren, Essex Junction, VT (US); Pascal Nsame, Essex Junction, VT (US); Aydin Suren, Essen Junction, VT (US)

Correspondence Address: CANTOR COLBURN LLP-IBM BURLINGTON, 20 Church Street, 22nd Floor, Hartford, CT, 06103, US

(21) Appl. No.: 12/049,600

(22) Filed: Mar. 17, 2008

(51) Int. Cl. G06F 17/28

(52) U.S. Cl. 704/2

(57) ABSTRACT

A method of enabling communication between a first person and a second person is disclosed. The method includes receiving at a server a message from the first person, the message addressed to the second person constructed in a first language; determining a preferred language of receipt of a message by the second person; determining whether the preferred language is different than the first language; translating the message from the first language to the preferred language of receipt of the second person to create a translated message whenever the preferred language is different than the first language; and delivering the translated message to the second person.

### BACKGROUND OF THE INVENTION

This invention relates generally to instant messaging, and more particularly to providing systems and methods for enabling instant messaging between users who communicate in different languages.

Instant messaging (often abbreviated simply to IM) offers real-time communication and allows easy collaboration, which might be considered more akin to genuine conversation than email's “letter” format. In contrast to e-mail, the parties know whether the peer is available. Most systems allow the user to set an online status or away message so peers are notified when the user is available, busy, or away from the computer. On the other hand, people are not forced to reply immediately to incoming messages. For this reason, some people consider communication via instant messaging to be less intrusive than communication via phone. However, some systems allow the sending of messages to people not currently logged on (offline messages), thus making Instant Messaging compatible with email.

Instant Messaging allows instantaneous communication between a number of parties simultaneously, by transmitting information quickly and efficiently, featuring immediate receipt of acknowledgement or reply. In certain cases Instant Messaging involves additional features, which make it even more popular, i.e. to see the other party, e.g. by using web-cams, or to talk directly for free over the Internet.

It is possible to save a conversation for later reference. Instant messages are typically logged in a local message history which closes the gap to the persistent nature of e-mails and facilitates quick exchange of information like URLs or document snippets (which can be unwieldy when communicated via telephone).

At present, instant messaging is conducted in only the language of the sender. That is, the sender of the message transmits the message in a first langauge and the message is received by the recipient(s) in that same language. Futhermore, if an attachment or linked document is sent, the attachment or linked document is displayed in the langage it was created in. In many instances, such a system is acceptable. However, if instant messaging is being used, for example, between persons who speak and/or write in different languages, such communications may be difficult. Further, if a sender is communicating with multiple recipients that speak different languages, keeping track of what language a certain recipient wants to receive messages in may become onerous. Also, in some business or personal settings, groups of users may speak several different languanges but may need to instantly communicate between themselves without having to send a message to each person in a separate langauge.

It would be desirable/advantageous to be able to allow for two or more users who communicate in different languages to utilize an instant messaging system without having to keep track of the various languages of various recipients.

### BRIEF SUMMARY OF THE INVENTION

An exemplary embodiment includes a method of enabling communication between a first person and a second person. The method of this embodiment includes receiving at a server a message from the first person, the message addressed to the second person constructed in a first language; determining a preferred language of receipt of a message by the second person; determining whether the preferred language is different than the first language; translating the message from the first language to the preferred language of receipt of the second person to create a translated message whenever the preferred language is different than the first language; and delivering the translated message to the second person.

Another embodiment of the present invention is directed to a system for enabling instant messaging communications among a plurality of users speaking a plurality of languages. The system of this embodiment includes means for receiving a message from first user in a first language for delivery to a second user, means for determining whether the first message should be translated to a second message based on a profile of a preferred language of receipt of the second user, means for translating the message from the first language to the second language, and means for delivering the message to the second user.

Another embodiment of the present invention is directed to a method of enabling communication between a first person and a second person. The method of this embodiment includes receiving at a server a message from the first person, the message addressed to the second person constructed in a first language; determining a preferred language of receipt of a message by the second person; determining whether the preferred language is different than the first language; prompting the second person to request a translation decision; receiving the translation decision; translating the message from the first language to the preferred language of receipt of the second person to create a translated message based on the translation decision; and delivering the translated message to the second person.

### BRIEF DESCRIPTION OF THE DRAWINGS

Referring now to the drawings wherein like elements are numbered alike in the several FIGURES:

FIG. 1 shows an example of a system on according to an embodiment of the present invention;

FIG. 2 is a flow chart of a method according to a embodiment of the present invention;

FIG. 3 is a more detailed flow chart of a portion of the method shown in FIG. 2;

FIG. 4 shows the screens of two persons in real-time as they may be utilizing embodiments of the present invention;

FIG. 5 shows an example of another method which may be employed by embodiments of the present invention; and

FIG. 6 shows an example of a profile that may be utilized by embodiments of the present invention.

### DETAILED DESCRIPTION OF EXEMPLARY EMBODIMENTS

An exemplary embodiment of the present invention provides systems and methods that enable a first user to send a message, such as an instant message, to one or more recipients that may communicate in a language different than the language the message was sent in. In some embodiments, a message is sent in a first language from a first user to a recipient that speaks, reads or otherwise communicates in another language. A profile of the recipient is consulted to determine their preferred language of receipt. The message may then be translated into the preferred language of the recipient. In some embodiments, a message may be sent to several recipients in a first language and received in several different languages by the several different recipients. In this manner, each of several persons in an instant message communication may see all of the messages in their own preferred language while the messages may have been sent in any language.

In some embodiments, attachments may also be translated before being delivered to the recipient(s). Such attachments may be sent as a link or as a translated copy of the document. In the case where the attachment is a link, a translated copy of the original document may be created at a central server and then transmitted to the recipient requesting the document, for example by clicking on the link.

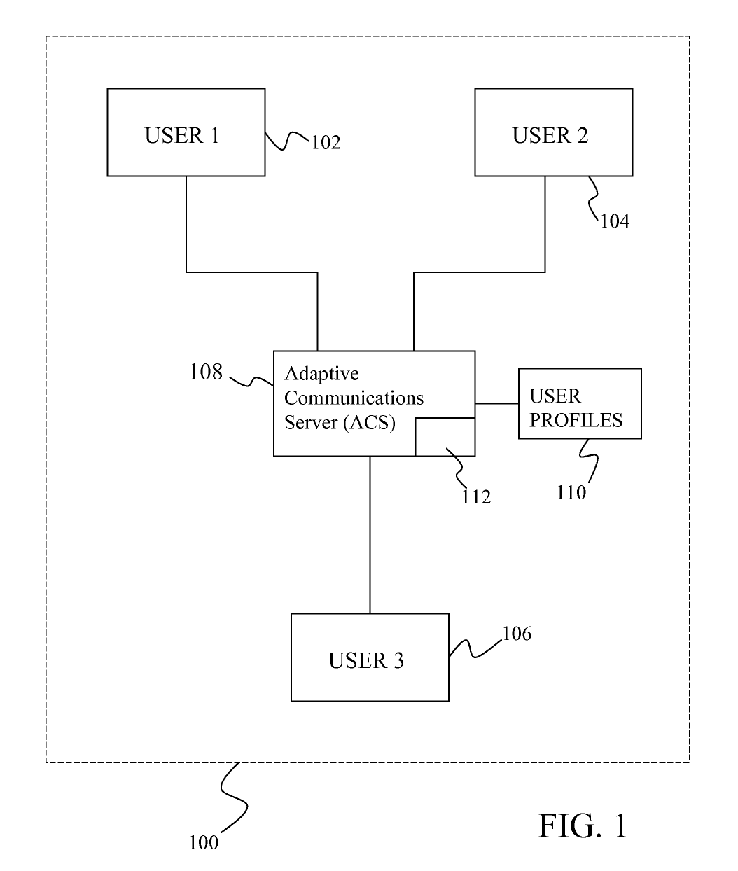

FIG. 1 shows an example of a system, according to the present invention, for conducting instant messaging among a plurality of users who may speak, read or otherwise communicate in different languages than at least one other participant in the instant messaging communication. The system 100 includes a plurality of users. These users may include, for example, user 1 102, user 2 104, and user 3 106. Of course, one of ordinary skill in the art will readily realize that the number of users is not limited to three, nor are three users required. For instance there could be two users or any other number of users. Each user in the system is coupled to an adaptive communication server 108. From time to time herein the adaptive communication 108 server will also be referred to herein as a central server.

The central server may include a translation software package 112. This translation software package 112 may, in some instances, be able to translate text from any language into any other language. In some embodiments, the translation software may also be able to translate spoken messages from one language to another. Examples of translation software packages are known in the art. The adaptive communication server 108 may also include memory for storing documents and messages as well as being used for receiving and transmitting/sending messages from a first user 102 to a second used 104, for instance.

The system 100 may also include user profiles 110. These user profiles 110 may be unique for each user or may be a single profile for all users of the system. Regardless, the user profiles 110 may be consulted by the central server to determine if a message from user 1 102 should be translated from the language it was sent in before being delivered, for example, to user 3 106. As one of ordinary skill in the art will readily realize the users 102, 104 and 106 could communicate with the central server 108 via a personal computer of any sort. Other electronic devices capable of connecting a user to the central server for the purpose of instant messaging may include, for example, any hand-held electronic wireless device such as a Blackberry, a cellular telephone or the like.

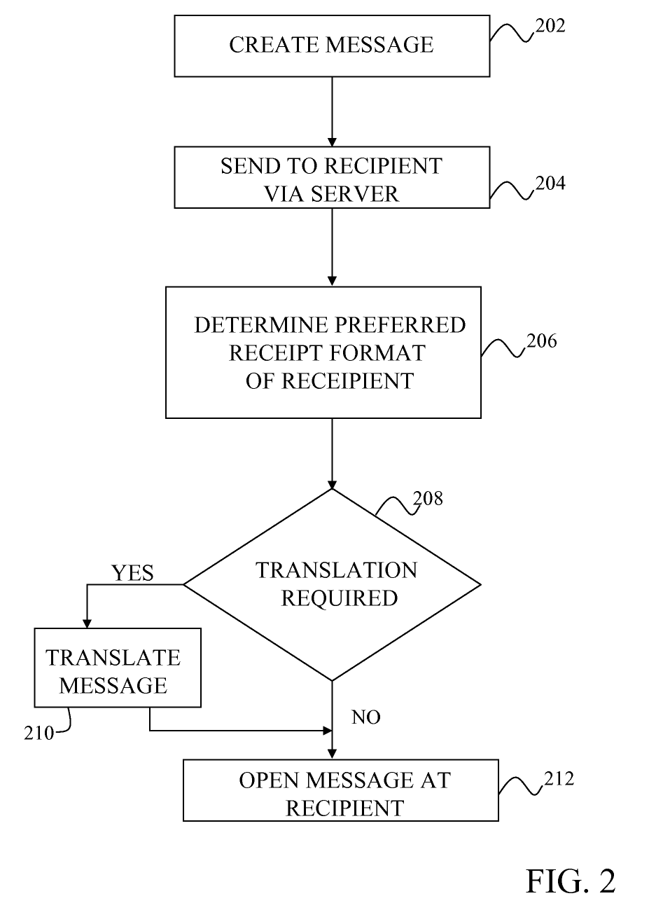

FIG. 2 shows an example of a process by which a message may be sent according to one embodiment of the present invention. The process starts at block 202 where a message is created. In one embodiment, the message may be created by a first user in a first language. In block 204, the message is sent via the central server to the recipient. At this point the message has not yet reached the recipient but is resident at the central server. It will be understood the term recipient may refer to multiple recipients who may speak any number of different languages other than the language in which the message was sent by the message sender. For instance, if an instant message is sent from a person resident in the United States, the message is more than likely sent in English, and if it was addressed to recipients in France and Germany, respectively, the recipients may expect to have the message appear in French and German. While the following description focuses on a message being sent from a first user to a second user, it should be understood that the message could be sent from a first user to multiple second users as previously described.

At block 206, the preferred receipt format of the recipient is determined. As discussed previously, and in greater detail below, this determination may be made by accessing a user profile (for example user profile 110, FIG. 1). In some instances, the profile with respect to the sender may assume that the sender always sends messages in a first format/language. However, as one of ordinary skill in the art will readily realize, the process shown in FIG. 2 may also include a step (not shown) of determining the format of the message from the first user. This may be done by various techniques known to those of skill in the art.

The language in which the message is sent is then compared to the preferred format of receipt of the recipient in block 208. If the two languages are different, the message is translated in block 210 and then opened at the recipient at block 212. If the languages are not different, the method progresses from block 208 directly to block 212.

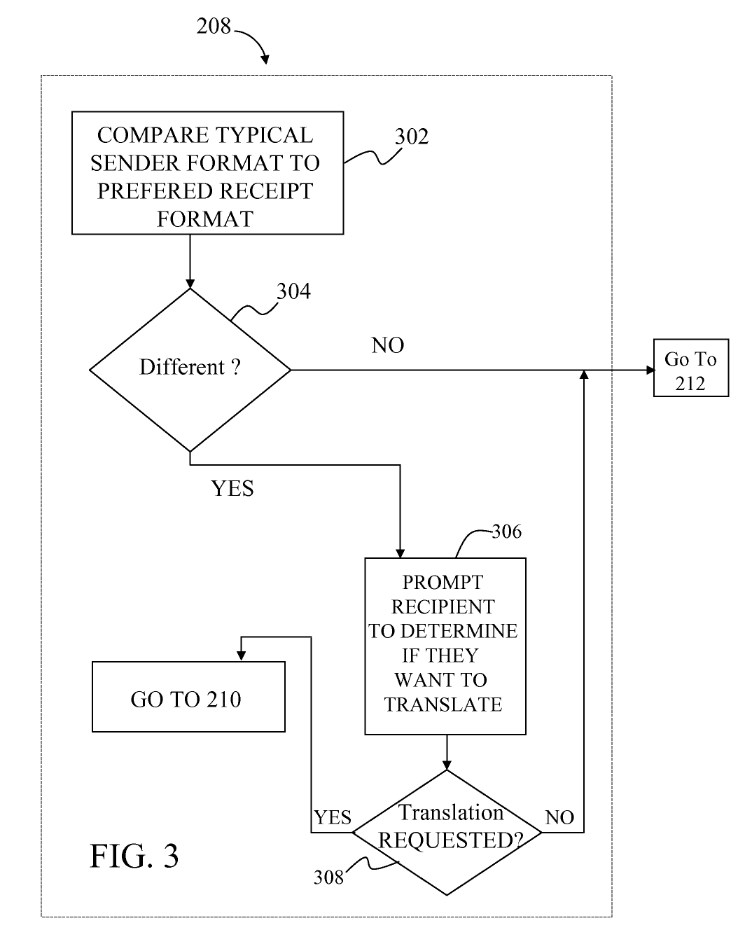

FIG. 3 shows a more detailed depiction of the process which may occur in block 208 of FIG. 2. The process begins at block 302 where the typical sender format is compared to the preferred receipt format of the recipient. If the two formats are different, as determined at block 304, the process progresses to optional block 306 where the recipient is prompted to determine if the recipient wants to have the message translated. For instance, the recipient may wish to conduct the conversation in the sender's format. An example of such an instance may occur if the person whose receiving the message wishes, for example, to study the language of the sender. The central server receives a response from the user indicating whether or not a translation is requested. If one is requested, control returns to block 210 shown in FIG. 2. If translation is not requested, the process returns to block 212 of FIG. 2.

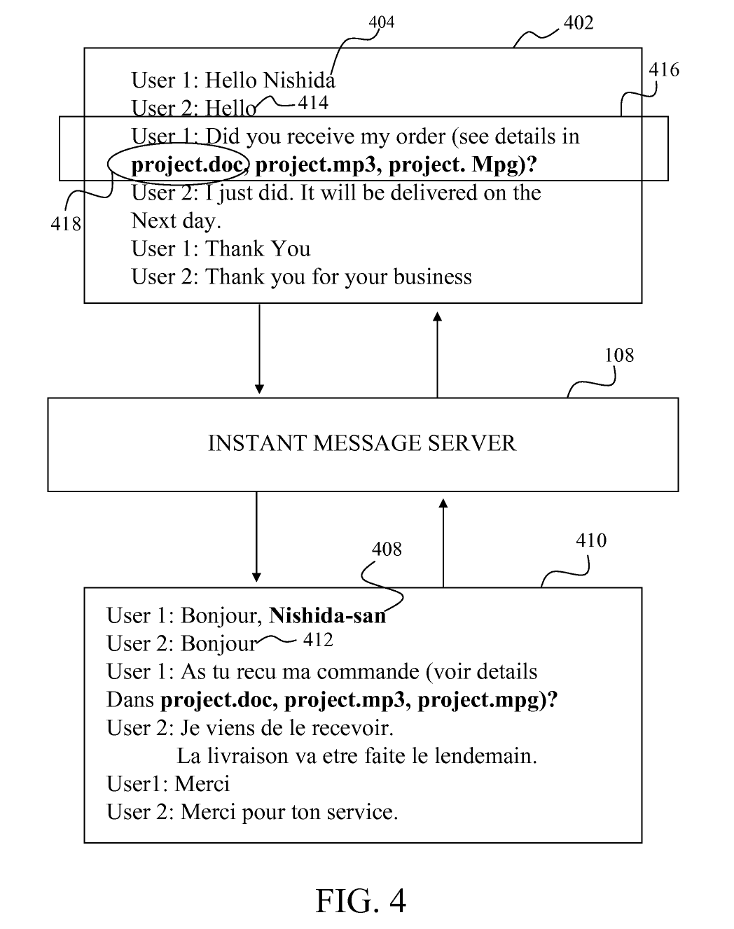

FIG. 4 shows an example of an instant message display as shown on both a sender's display 402 and a recipient's display 410 and includes a link between the two showing the location of the central server 108. The sender's display 402 shows the initial conversation piece 404. As shown, this communication appears in English. The same communication, translated into French, appears as the initial receiver conversation piece 408 on the recipient's display 410. The reply of the recipient is shown in French in the second recipient's conversation piece 412 on the recipient's display 410 and in English in the second sender's conversation piece 414. The third sender's conversation piece 416 contains not only text but also includes attachments, for example, attachment 418. The attachment may be a copy of the item or may be a link to the item stored, for example, in the central server 108.

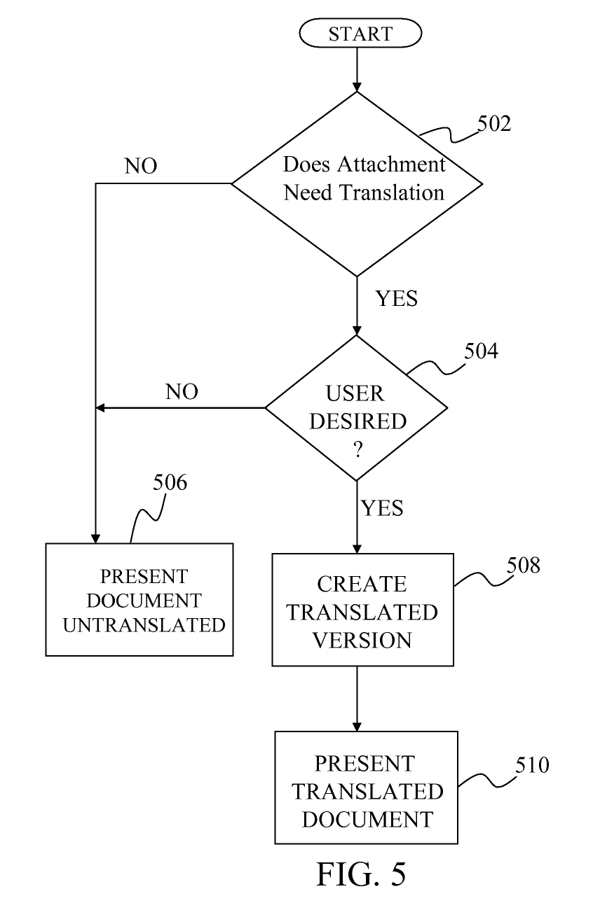

FIG. 5 shows an example of a process that may be performed if it is determined by the central sever that the message includes an attachment. As discussed previously above, the attachment could be an actual document or a link to a document that is contained on the central server. Regardless, it is determined by block 502 whether or not the attachment needs translation. As discussed above, this may be accomplished by utilizing a profile. In some instances it may be assumed that the sender's and receiver's typical sending and receiving formats also apply to attachments. If a translation is needed, at block 504 it is optionally determined whether or not the user wishes to have the attachment translated. As discussed previously, the process in block 504 related to determining whether a user wished to have an attachment translated may be omitted and may be accomplished by prompting the receiver.

Regardless, if the attachment needs translation, a translated version is created at the central server at block 508 and may be presented to the recipient at block 510. If either the document does not need translation or the user does not wish the attachment be translated the attachment may be presented to the second user at block 506.

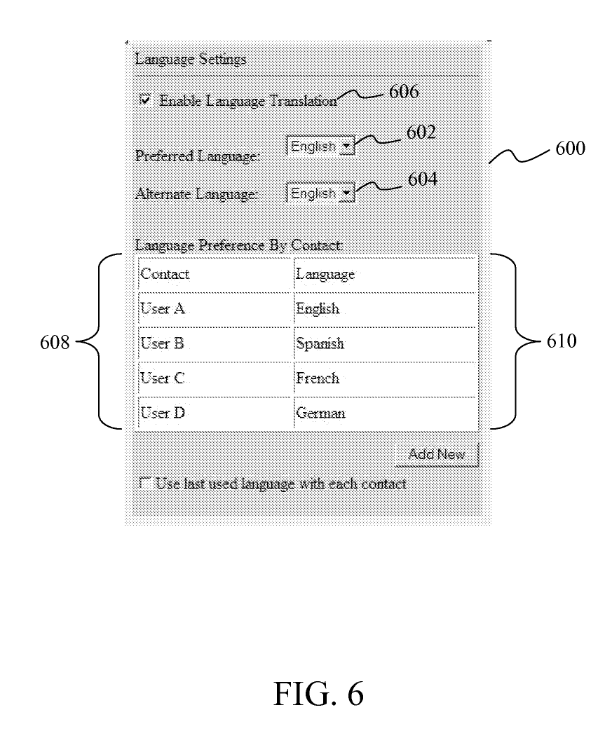

FIG. 6 shows one example of a profile 600 according to an embodiment of the present invention. The profile 600, in this instance, is for an individual user. Such a profile could be kept for each user of the system. Of course, a single profile containing preferences of all users may be implemented in accordance with the present invention. In other embodiments, groups of users may be contained on separate profiles.

Regardless, the profile 600 includes a field indicating the user's preferred language 602. Optionally, the profile may also include a field indicating the user's alternate language 604. The profile may be configurable to enable or disable translation abilities based, in this example, by the enable translation field 606. The profile 600 may include a list of contacts 608 and a corresponding list of preferred languages by contact 610. As discussed above, the profile may be consulted to determine if translation is required.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method of enabling communication between a first person and a second person, the method comprising:
receiving at a server a message from the first person, the message addressed to the second person constructed in a first language;
determining a preferred language of receipt of a message by the second person;
determining whether the preferred language is different than the first language;
translating the message from the first language to the preferred language of receipt of the second person to create a translated message whenever the preferred language is different than the first language; and
delivering the translated message to the second person.

2. The method of claim 1, further comprising:
prompting the second person to request a translation decision; and
receiving the translation decision.

3. The method of claim 1, wherein determining the preferred language includes accessing a profile containing a language preference for one or more users.

4. The method of claim 3, wherein determining if the preferred language is different than the first language includes comparing a language preference for the first user contained in the profile with a language preference for the second user contained in the profile.

5. The method of claim 1, further comprising:
determining whether the message includes an attachment;
determining the creation language of the attachment; and
translating the attachment whenever the creation language of the attachment is different than the preferred language of receipt of the second person.

6. The method of claim 5, further comprising:
creating and storing a translated version of the attachment on a central server.

7. The method of claim 5, further comprising:
prompting the second person to request an attachment translation decision; and
receiving the attachment translation decision.

8. The method of claim 5, wherein the attachment is a document.

9. The method of claim 5, wherein the attachment is a link to a file maintained on a central server.

10. A system for enabling instant messaging communications among a plurality of users speaking a plurality of languages, the system comprising:
means for receiving a message from first user in a first language for delivery to a second user;
means for determining whether the first message should be translated to a second message based on a profile of a preferred language of receipt of the second user;
means for translating the message from the first language to the second language; and
means for delivering the message to the second user.

11. The system of claim 10, wherein the means for receiving and the means for delivering are implemented on a network server.

12. The system of claim 10, wherein the means for determining include means for accessing the profile containing a preferred language of receipt of the second user.

13. The system of claim 12, wherein the means for determining include means for prompting the second user for a translation decision.

14. A method of enabling communication between a first person and a second person, the method comprising:
receiving at a server a message from the first person, the message addressed to the second person constructed in a first language;
determining a preferred language of receipt of a message by the second person;
determining whether the preferred language is different than the first language;
prompting the second person to request a translation decision;
receiving the translation decision;
translating the message from the first language to the preferred language of receipt of the second person to create a translated message based on the translation decision; and
delivering the translated message to the second person.

15. The method of claim 14, wherein determining the preferred language includes accessing a profile containing a language preference for one or more users.

16. The method of claim 15, wherein determining whether the preferred language is different than the first language includes comparing a language preference for the first user contained in the profile with a language preference for the second user contained in the profile.

17. The method of claim 14, further comprising:
determining whether the message includes an attachment;
determining the creation language of the attachment; and
translating the attachment whenever the creation language of the attachment is different than the preferred language of receipt of the second person.

18. The method of claim 17, further comprising:
creating and storing a translated version of the attachment on a central server.
